(19) United States
(12) Patent Application Publication
(10) Pub. No.: US 2005/0108333 A1
(43) Pub. Date: May 19, 2005

(54) Blocking input with delayed message

(76) Inventors: Martin Scholz, Nussloch (DE); Uwe Klinger, Bad Schoenborn (DE); Matthias Vering, Bad Schoenborn (DE); Udo Klein, Maximiliansau (DE)

Correspondence Address: FISH & RICHARDSON, P.C., 3300 DAIN RAUSCHER PLAZA, 60 SOUTH SIXTH STREET, MINNEAPOLIS, MN, 55402, US

(21) Appl. No.: 10/698,956

(22) Filed: Oct. 31, 2003

(51) Int. Cl. G06F 15/16; G06F 11/30; H04L 9/32; G06F 12/14

(52) U.S. Cl. 709/206; 713/200; 709/229

(57) ABSTRACT

Input blocking with delayed message is described. A server device may provide executable code to a client device which code when executed blocks the input device from receiving user input during its communications with the server device. If any of the communications lasts longer than a specific time, a message is presented to a user of the client device. The executable code may be framework code that the server provides to the client device to provide for their communications. The specific time may be set based on user expectations or on typical roundtrip times for client-server communications.

### TECHNICAL FIELD

This description relates to blocking user input and presenting a message to a user.

### BACKGROUND

Applications in a client-server system often include software on the server side, referred to as a back end, and software on the client device(s), referred to as a front end. A front end typically can initiate a communication between the client device and the server device to share data, obtain data from the back end, or for other purposes. The initiation of the communication, its duration, and the conclusion is collectively known as a roundtrip between the front end and back end.

The response from the back end may be a confirmation that it received data from the front end. In other situations, however, the back end response may involve field contents being changed in the front end, or the back end may have changed from one state to another during the roundtrip, to name a few examples. The consequence of this may be that certain user-initiated events in the front end (such as pressing a button or editing a field) may no longer be permitted after the roundtrip. It is therefore important that the client device is blocked from receiving input during the roundtrip, or the system may have to deal with a potentially contradictory input being made.

With roundtrips that take relatively short time, the user may not notice that input is being blocked. Even if the user does notice the input-blocking, the inconvenience typically is marginal due to the short duration. A longer roundtrip, on the other hand, may be distracting and confusing to the user if there is no indication of why input is being blocked.

This problem is somewhat alleviated in systems that display a message during the roundtrip. That is, a message box may be displayed when input blocking begins and may remain visible throughout the roundtrip. One disadvantage with this approach is that it can cause uneven dynamic behavior of the front end. Another disadvantage is that the message is displayed regardless of how long the roundtrip lasts. For short roundtrips, the sudden display and then disappearance of the message box may not be helpful to the user, particularly if it flashes by in such a short time that the user cannot read the message.

It may be possible to implement a particular behavior in certain front end functions. It appears that in the Outlook 2000 program from Microsoft Corp., the function “Empty ‘Deleted Items’ Folder” delays display of a message to the user (with a conventional graphic “progress meter”) after the command is executed. Other functions in the Outlook 2000 program, however, do not display a message regardless of how long the client-server communication takes. This approach is associated with disadvantages. Implementing a delay functionality for a specific input function requires special programming and may call for extensive coordination in development of application programs. Moreover, if such functionality needs to be triggered by a message from the server that the roundtrip is not yet finished, a message will not be displayed if delay is due to slow network connection.

### SUMMARY

The invention relates to blocking input with delayed message. In a first general aspect, a method of informing a user about communications between a client device and a server device comprises providing executable code from a server device to a client device that is capable of communicating with the server device, which code when executed blocks the client device from receiving user input during communications between the client device and the server device. If any of the communications between the client device and the server device lasts longer than a specific time, the code causes a message to be presented to a user of the client device.

In selected embodiments, the executable code is client-side framework code provided from framework code in the server device that controls communications between the server device and client devices.

The specific time may be set based on one or more reference times, such as a measured roundtrip time, typical roundtrip times in the system, or a roundtrip time expected by the user(s).

In a second general aspect, a method of informing a user about communications between a client device and a server device comprises receiving executable code provided from a server device to a client device. Per the executable code, the client device is blocked from receiving user input during its communications with a server device. Per the executable code, a message is presented to a user of the client device if any of the communications lasts longer than a specific time.

In a third general aspect, a computer system comprises a server device with server-side framework code which when executed on the server device establishes a client-server framework for client-server communications. The computer system comprises a client device with client-side framework code provided from the server device. When executed on the client device, the client-side framework code blocks the client device from receiving user input during the client-server communications. If any of the client-server communications lasts longer than a specific time, the client-side framework code causes a message to be presented to a user of the client device.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 shows a block diagram of a computer system with input blocking and delayed message on a client device;

FIGS. 2 and 3 are examples of displays on the client device shown in FIG. 1; and

FIG. 4 shows flow charts of methods of blocking user input and presenting delayed message.

Like reference numerals in the various drawings indicate like elements.

### DETAILED DESCRIPTION

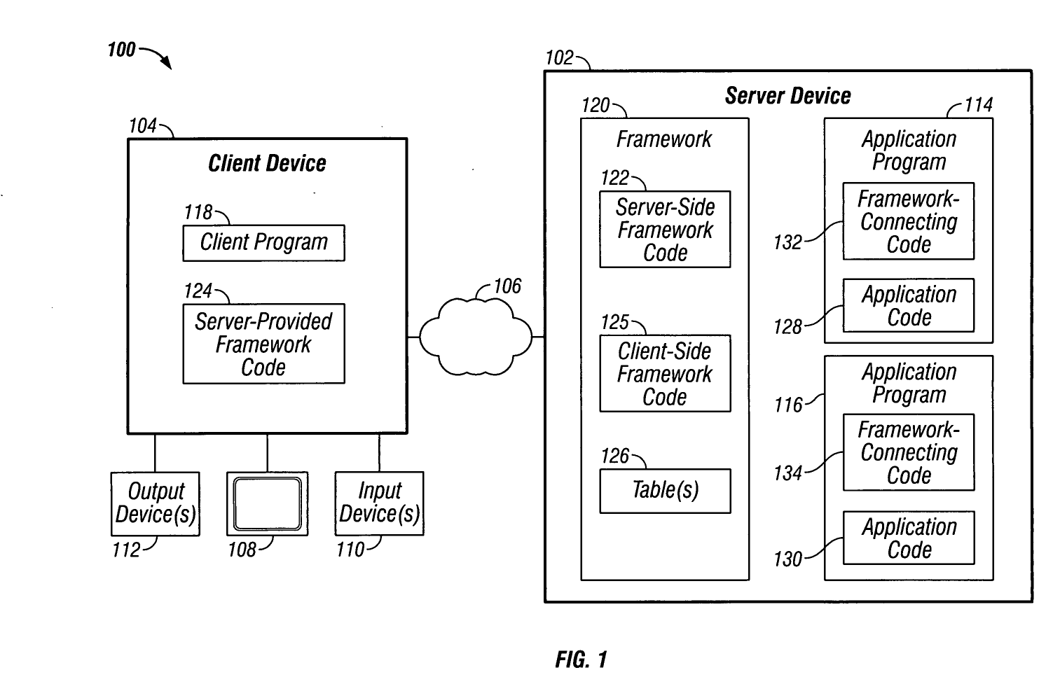

FIG. 1 shows a computer system 100 including a server device 102 and a client device 104 connected by a network 106. A display device 108, input device(s) 110 and output device(s) 112 operably connected to client device 104 provide that a user can interact with one or more application programs 114, 116 on the server device 102. A client program 118 on the client device 104, such as a graphical user interface or a browser, may facilitate this interaction. As will be described below, user input to the client device 104 may be blocked during client-server communications and a message presented to the user if any of the communications takes longer than a certain time.

The system 100 may have a framework 120 for communications between the server device 102 and the client device 104. The framework 120 may be established by execution of server-side framework code 122. On the client device 104 there may be server-provided framework code 124. The server device 102 may provide server-provided framework code 124 to the client device 104 in form of a copy of client-side framework code 125 on the server device 102. The server-provided framework code 124 may be transmitted to the client device 104 upon connecting the client device 104 to the server device 102. Table(s) 126 may contain application-independent information relating to settings or customization of the framework. The framework 120, including the server-provided framework code 124, facilitates communications between the devices. The application programs 114, 116 are configured so that the framework 120 lets the user interact with them from the client device 104. For example, the programs 114, 116 which include respective application codes 128, 130, may have framework-connecting codes 132 and 134 that make them compatible with the framework. The framework-connecting codes 132, 134 may be identical or different in different programs 114, 116.

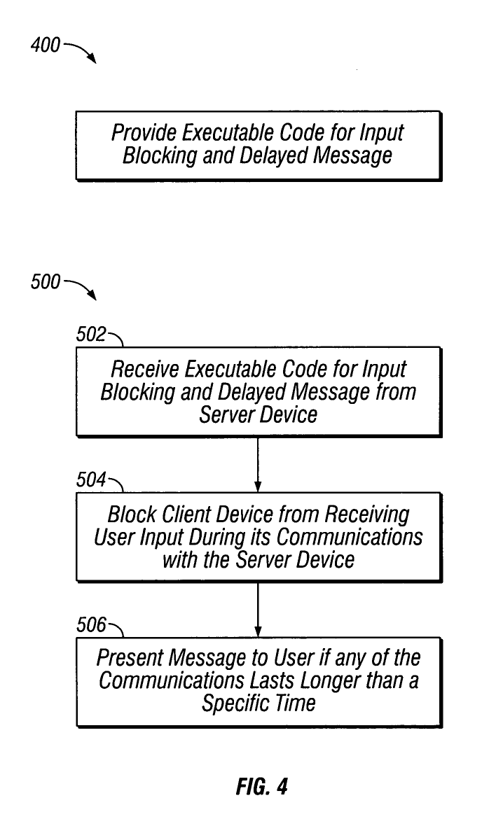

The server device 102 provides 400 (see FIG. 4) executable code (such as code 124) to the client device 104. The client device receives 502 (see FIG. 4) the executable code which provides input blocking and delayed message during connections between the client device and the server device. Client-server communications can be initiated from the client device 104. During the communications, the server-provided framework code 124 blocks 504 (see FIG. 4) the client device 104 from receiving user input. If any of the communications lasts longer than a predetermined time, the code 124 causes 506 (see FIG. 4) a message to be presented to the user of client device 104.

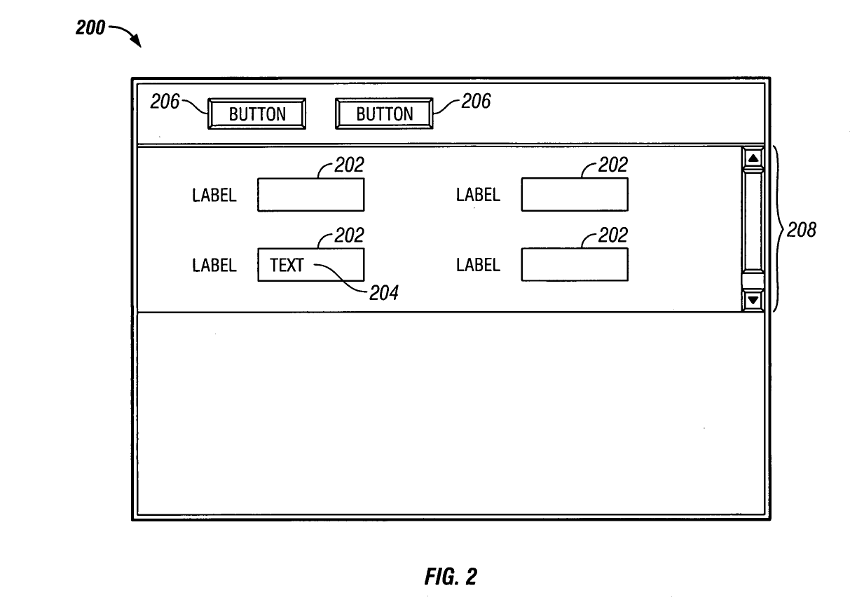

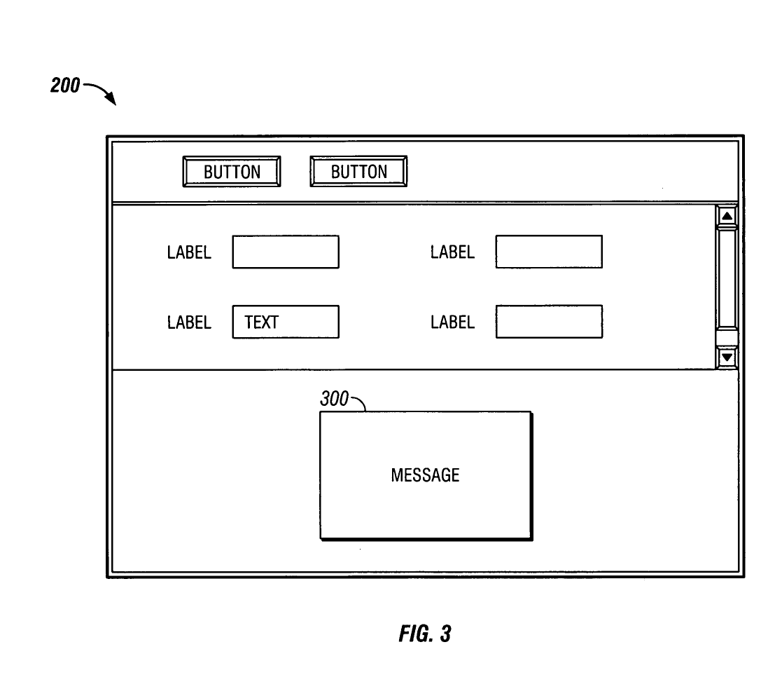

An example of a client-server communication in system 100 will be described with reference to FIGS. 2 and 3. Panel 200 can appear on display device 108, perhaps while the user is interacting with program(s) 114, 116. Particularly, some operation in the panel 200 may trigger a communication between the server device 102 and the client device 104. For example, the user makes an input in one of four input fields 202, optionally followed by hitting the “Enter” key on a keyboard. Here, the user has made the input 204 (the string “TEXT”) in one of the input fields 202. Another example is that the user clicks on one of input functions 206 (here function buttons) to initiate an operation. Yet another example is that the user scrolls a portion of the panel 200 using scrolling function 208.

The client device 104 then initiates a communication over the network 106 for the server device 102 to take some action. The server-provided framework code 124 begins blocking input to the client device 104. When the server device 102 is done, it will send a response to the client device and the server-provided framework code 124 will cease to block input to the client device. Preferably, the input blocking does not change the appearance of panel 200.

The time before a response is received from the server device 102 may depend on the amount of data being transmitted in the communication, a condition of the network 106 and on how quickly the server device finishes the action. If the communication is finished before a specific time, the input blocking ceases without a message being presented to the user. If the communication lasts longer than a specific time, the server-provided framework code 124 causes a message 300 to be presented to the user (see FIG. 3). The server-provided framework code 124 can allow one or more programs 114, 116 to provide an over-definition of a default message that would otherwise be presented. That is, when a communication exceeds the specified time, the message presented is one specified by an application program to replace a default message that the framework is capable of presenting. Non-visual messages can be presented using output device(s) 112, such as a speaker.

In one implementation, a specific time of about 2.5 seconds has been found useful. The specific time may be selected based on one or more reference times. One exemplary reference is a time after which users on average expect a response from the system. This expectancy time can be determined by monitoring test persons working with a system that subjects them to roundtrip times of varying length.

Another exemplary reference is an average time for roundtrips in the system 100. This can be determined by measuring roundtrip times while the system is being used. Optionally, this may be a “learning” measurement that is updated over time. One or more roundtrip times can be monitored during runtime and corresponding adjustment(s) in the specific time used by the server-provided framework code 124 can be made. For example, the client device 104 can record the roundtrip time(s).

FIG. 4 are flow charts of methods 400 and 500. Preferably, the method 400 is performed by a server device and the method 500 is performed by a client device. For example, a computer program product can include instructions that cause a processor of the server device to perform the step of method 400. For example, a computer program product can include instructions that cause a processor of the client device to perform the steps of method 500. The server device provides 400 executable code to a client device. The client device receives 502 executable code from the server device. When the code is executed, the client device is blocked 504 from receiving user input during its communications with the server device. If any of the communications lasts longer than a specific time, a message is presented 506 to a user of the client device.

Blocking input with delayed message as described herein may have any of the following advantages. Applying this feature to all client-server communications improves the feedback to the user during the communications. The feature can be implemented such that it need not be specifically coded for every function that it should apply to, without having to coordinate development of several functions or several application programs. Implementing the feature does not require analysis of which input functions are likely to move large amounts of data between the client and server. The feature works whether the roundtrip takes longer due to the amount of data transferred, network capacity or the server's availability.

The invention can be implemented in digital electronic circuitry, or in computer hardware, firmware, software, or in combinations of them. Apparatus of the invention can be implemented in a computer program product tangibly embodied in an information carrier, e.g., in a machine-readable storage device or in a propagated signal, for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the invention can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The invention can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. Accordingly, other embodiments are within the scope of the following claims.

1. A method of informing a user about communications between a client device and a server device, the method comprising:
providing executable code from a server device to a client device that is capable of communicating with the server device, which code when executed blocks the client device from receiving user input during communications between the client device and the server device and, if any of the communications between the client device and the server device lasts longer than a specific time, causes a message to be presented to a user of the client device.

2. The method of claim 1, wherein the executable code is client-side framework code provided from framework code in the server device that controls communications between the server device and client devices.

3. The method of claim 1, further comprising providing the executable code in response to the server device receiving a request from the client device to launch an application program capable of initiating the communications.

4. The method of claim 3, further comprising providing application program code to the client device wherein the message is an over-definition of a default message.

5. The method of claim 1, wherein a communication lasts longer than the specific time due to network delays, server-side delays, or combinations thereof.

6. The method of claim 1, wherein a communication lasts longer than the specific time when the client device has not displayed a server response within the specific time.

7. The method of claim 1, wherein the executable code ceases to block the client device from receiving user input after each communication has ended.

8. The method of claim 1, wherein the executable code causes the message to be presented on the client device during one of the communications and causes the client device to cease presenting the message after that communication has ended.

9. The method of claim 1, further comprising setting the specific time based on at least one selected from the group consisting of: a roundtrip time for a communication between the server device and the client device, typical roundtrip times for communications between the server device and the client device, a roundtrip time expected by at least one user of the client device, and combinations thereof.

10. A computer program product containing executable instructions that when executed cause a processor to perform operations comprising:
provide executable code from a server device to a client device that is capable of communicating with the server device, which code when executed blocks the client device from receiving user input during communications between the client device and the server device and, if any of the communications between the client device and the server device lasts longer than a specific time, causes a message to be presented to a user of the client device.

11. A method of informing a user about communications between a client device and a server device, the method comprising:
receiving executable code provided from a server device to a client device;
blocking, per the executable code, the client device from receiving user input during its communications with a server device; and
presenting, per the executable code, a message to a user of the client device if any of the communications lasts longer than a specific time.

12. The method of claim 11, wherein the presented message is an over-definition of a default message.

13. The method of claim 11, further comprising setting the specific time based on at least one selected from the group consisting of: a roundtrip time for a communication between the server device and the client device, typical roundtrip times for communications between the server device and the client device, a roundtrip time expected by at least one user of the client device, and combinations thereof.

14. A computer program product containing executable instructions that when executed cause a processor to perform operations comprising:
block a client device from receiving user input during its communications with a server device; and
cause a message to be presented to a user of the client device if any of the communications lasts longer than a specific time.

15. A computer system comprising:
a server device with server-side framework code which when executed on the server device establishes a client-server framework for client-server communications; and
a client device with client-side framework code provided from the server device, which client-side framework code when executed on the client device blocks the client device from receiving user input during the client-server communications and, if any of the client-server communications lasts longer than a specific time, causes a message to be presented to a user of the client device.

16. The computer system of claim 15, wherein the client-side framework code when executed causes the message to be presented for client-server communications that last longer than the specific time due to network delays, server-side delays, or combinations thereof.

17. The computer system of claim 15, wherein the message is an over-definition of a default message.

18. The computer system of claim 15, wherein the client-side framework code causes the message to be displayed on the client device.

19. The computer system of claim 15, wherein the specific time is based on at least one selected from the group consisting of: typical roundtrip times for communications between the server device and the client device, a roundtrip time expected by at least one user of the client device, and combinations thereof.

20. The computer system of claim 15, wherein at least one roundtrip time for a communication between the server device and the client device is recorded and the specific time is set based on the at least one roundtrip time.
